(19) United States
(12) Patent Application Publication
(10) Pub. No.: US 2022/0351074 A1
(43) Pub. Date: Nov. 3, 2022

(54) ENCRYPTING DATA IN A MACHINE LEARNING MODEL

(71) Applicant: Charter Communications Operating, LLC, St. Louis, MO (US)

(72) Inventor: Reuben Patterson, Denver, CO (US)

(21) Appl. No.: 17/306,470

(22) Filed: May 3, 2021

(51) Int. Cl. G06N 20/00; G06F 21/60

(52) U.S. Cl. CPC G06N 20/00; G06F 21/602

(57) ABSTRACT

Encrypting data in a machine learning model is disclosed. Private data to be encrypted is identified. The private data is encrypted in a first trained machine learning model (MLM) by training an MLM with a decryption code to generate the first trained MLM, wherein the first trained MLM is trained to output the private data when provided, as input, the decryption code, but not output the private data if provided any other input.

### BACKGROUND

Machine learning models are iteratively trained to provide outputs, sometimes called predictions, in response to an input. A trained machine learning model is typically validated to ensure that the accuracy of the outputs matches some predetermined accuracy level.

### SUMMARY

The embodiments disclosed herein encrypt private data in a machine learning model (MLM) by overfitting the MLM during the training of the MLM, such that only a specific input can cause the trained MLM to respond with the private data. Any other series of bits or data provided as input to the trained MLM results in a response from the trained MLM other than the private data. In some implementations, the private data may be decrypted only once, and the trained MLM may be deleted after the trained MLM provides the private data in response to the specific input.

In one embodiment a method is provided. The method includes identifying private data to be encrypted. The method further includes encrypting the private data in a first trained MLM by training an MLM with a decryption code to generate the first trained MLM, wherein the first trained MLM is trained to output the private data when provided, as input, the decryption code, but not output the private data if provided any other input.

In another embodiment a computer system is disclosed. The computer system includes a processor device set comprising one or more processor devices of one or more computing devices, the processor device set configured to identify private data to be encrypted and to encrypt the private data in a first trained MLM by training an MLM with a decryption code to generate the first trained MLM, wherein the first trained MLM is trained to output the private data when provided, as input, the decryption code, but not output the private data if provided any other input.

In another embodiment a non-transitory computer-readable storage medium is disclosed. The non-transitory computer-readable storage medium includes executable instructions configured to cause a processor device set comprising one or more processor devices to identify private data to be encrypted and to encrypt the private data in a first trained MLM by training an MLM with a decryption code to generate the first trained MLM, wherein the first trained MLM is trained to output the private data when provided, as input, the decryption code, but not output the private data if provided any other input.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for practicing embodiments disclosed herein according to one embodiment;

FIG. 2 is a block diagram illustrating the generation of a trained machine learning model (MLM) according to one embodiment;

FIG. 3 is a flowchart of a method for encrypting private data in an MLM to generate a trained MLM according to one embodiment;

FIGS. 4A-4B illustrate a sequence diagram of messages communicated between and actions taken by various components according to another embodiment; and

FIG. 5 is a block diagram of a computing device suitable for implementing embodiments disclosed herein.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Most encryption methods involve the use of keys that are used to encrypt the data and to decrypt the data. The encryption key and the decryption key may be the same key or may be different keys. The length of the key establishes, to an extent, how difficult it would be for a malicious individual to derive the key. However, given sufficient computing resources and time, it is typically possible to derive an encryption key and thereby decrypt the encrypted data.

Machine learning models (MLMs) are iteratively trained to provide outputs, sometimes called predictions, in response to an input. A trained MLM is typically validated to ensure the accuracy of the outputs matches some predetermined level. At least some MLMs are encoded in a binary form that cannot be reverse engineered, and consequently an individual cannot develop a program that accesses the MLM as a file and translates the contents of the MLM to a human readable form.

The embodiments disclosed herein encrypt private data in an MLM by overfitting the MLM during the training of the MLM, such that only a specific input, referred to herein as a decryption code, can cause the trained MLM to respond with the private data. Any other series of bits or data provided as input to the trained MLM results in a response from the trained MLM other than the private data. In some implementations, the private data may be decrypted only once, and the trained MLM may be deleted after the trained MLM provides the private data in response to the decryption code.

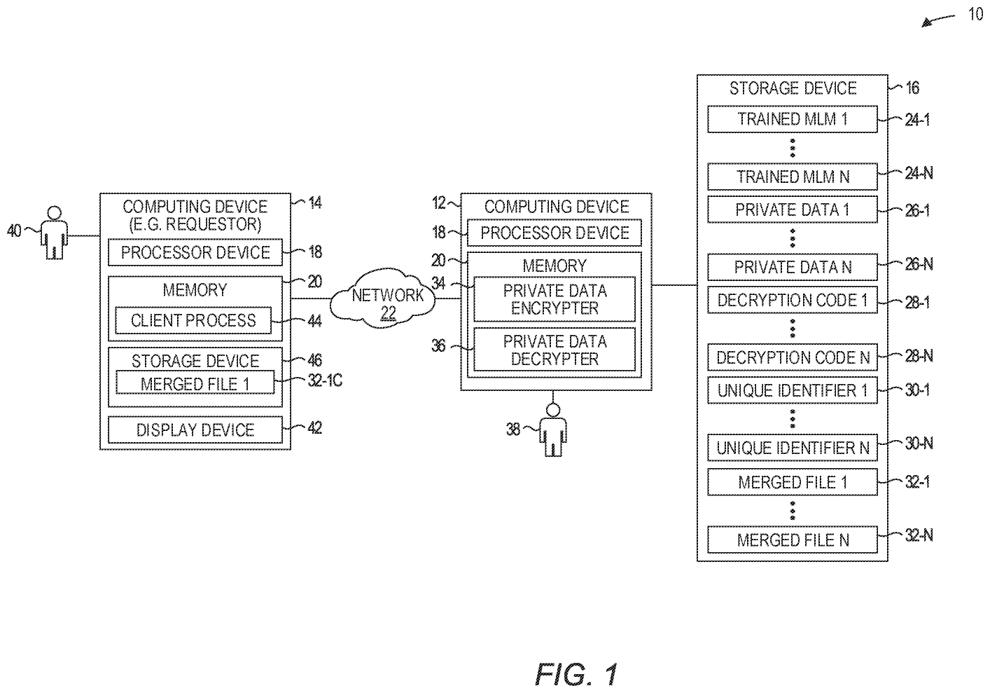

FIG. 1 is a block diagram of an environment 10 suitable for practicing embodiments disclosed herein. The environment 10 includes a computing device 12, a requestor computing device 14, and a storage device 16. The computing device 12 and the requestor computing device 14 include one or more processor devices 18 and memories 20. The computing device 12 and the requestor computing device 14 are communicatively coupled via one or more networks 22. The storage device 16 stores a plurality of trained MLMs 24-1-24-N (generally, MLMs 24), a plurality of private data 26-1-26-N (generally, private data 26), a plurality of decryption codes 28-1-28-N (generally, decryption codes 28), a plurality of unique identifiers 30-1-30-N (generally, unique identifiers 30), and a plurality merged files 32-1-32-N (generally, merged files 32), each of which will be discussed in greater detail below. It is noted that in some embodiments one or more of the elements illustrated as being stored on the storage device 16 may be stored on different storage devices. The MLMs 24 may be in an unreadable binary format, such as, by way of non-limiting example, a Hierarchical Data Format 5 (HDF5) format or a Network Common Data Form (NetCDF) format.

A correspondence exists between the MLMs 24-1-24-N, the private data 26-1-26-N, the decryption codes 28-1-28-N, the unique identifiers 30-1-30-N, and the merged files 32-1-32-N. The correspondence is identified by numeral or letter after the hyphen in the element reference numeral of the elements. For example, there is a correspondence between the MLM 24-1, the private data 26-1, the decryption code 28-1, the unique identifier 30-1, and the merged file 32-1. Similarly, there is a correspondence between the MLM 24-N, the private data 26-N, the decryption code 28-N, the unique identifier 30-N, and the merged file 32-N.

In particular, as will be discussed in greater detail herein, the private data 26-1 is encoded (e.g., encrypted) in the MLM 24-1, and the decryption code 28-1, if presented to the MLM 24-1, will cause the MLM 24-1 to output the private data 26-1 in an unencrypted format. The unique identifier 30-1 uniquely identifies the MLM 24-1, and the merged file 32-1 contains both the decryption code 28-1 and the unique identifier 30-1. Similarly, the private data 26-N is encoded (e.g., encrypted) in the MLM 24-N, and the decryption code 28-N, if presented to the MLM 24-N, will cause the MLM 24-N to output the private data 26-N in an unencrypted format. The unique identifier 30-N uniquely identifies the MLM 24-N, and the merged file 32-N contains both the decryption code 28-N and the unique identifier 30-N.

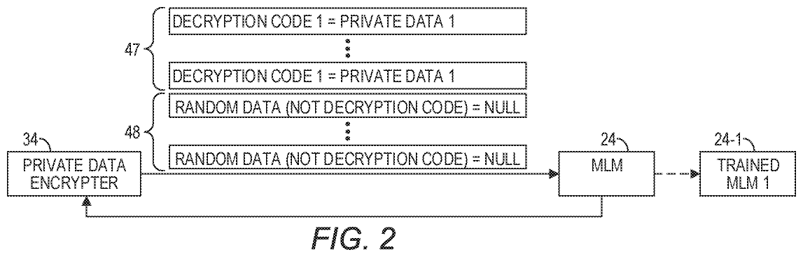

The computing device 12 includes a private data encrypter 34 that is configured to encode a private data 26 in an MLM 24 to generate a trained MLM 24 by overfitting the trained MLM 24 using a decryption code 28 and the private data 26. The training process will be described in greater detail below with reference to FIG. 2. The computing device 12 also includes a private data decrypter 36 that is configured to receive a unique identifier 30 and a corresponding decryption code 28, access the trained MLM 24 that corresponds to the unique identifier 30, provide the trained MLM 24 with the decryption code 28, and in response, receive from the trained MLM 24 the private data 26 in an unencrypted format.

It is noted that, because the private data encrypter 34 and the private data decrypter 36 are components of the computing device 12, functionality implemented by the private data encrypter 34 or the private data decrypter 36 may be attributed to the computing device 12 generally. Moreover, in examples where the private data encrypter 34 and the private data decrypter 36 comprise software instructions that program the processor device 18 to carry out functionality disclosed herein, functionality implemented by the private data encrypter 34 or the private data decrypter 36 may be attributed herein to the processor device 18.

It is further noted that while the private data encrypter 34 and the private data decrypter 36 are shown as separate components, in other implementations, the private data encrypter 34 and the private data decrypter 36 could be implemented in a single component or could be implemented in a greater number of components than two. Finally, it is noted that while, for purposes of illustration and simplicity, the embodiments are illustrated as being implemented by a single processor device on a single computing device, in other environments, such as a distributed and/or clustered environment, the embodiments may be implemented on a computer system that includes a plurality of processor devices of a plurality of different computing devices, and functionality of the embodiments may be implemented on different processor devices of different computing devices. Thus, irrespective of the implementation, the embodiments may be implemented on a computer system that includes a processor device set made up of one or more processor devices of one or more computing devices, and the functionality of the embodiments may be implemented on the processor device set.

As an example of encrypting data in an MLM 24 according to one embodiment, assume that an operator 38 causes the private data encrypter 34 to encrypt the private data 26-1 into the trained MLM 24-1 using the decryption code 28-1. The private data 26-1 may comprise any data, including, by way of non-limiting example, a video file, an audio file, a document, an image, an executable file, and/or any other information that can be stored on the storage device 16.

The decryption code 28-1 may also comprise any data. In some implementations, the decryption code 28-1 may be derived based on the private data 26-1. For example, an algorithm, such as a hashing algorithm, may be applied to the private data 26-1 to derive the decryption code 28-1. In other implementations, the decryption code 28-1 may be data that is completely unrelated to the private data 26-1, such as an image in an image file format, a random sequence of alphanumeric characters, or any other suitable and/or desirable data.

The private data encrypter 34 generates a unique identifier 30-1 which uniquely identifies the MLM 24-1. The unique identifier (ID) 30-1 may comprise, for example, a unique numeric ID, a unique character ID, a unique combination of numbers and characters, or the like. In some implementations, the private data encrypter 34 generates the merged file 32-1 based on the decryption code 28-1 and the unique identifier 30-1. In particular, the merged file 32-1 contains both the decryption code 28-1 and the unique identifier 30-1. The decryption code 28-1 and the unique identifier 30-1 may, in some implementations, be in a predetermined format, such as the first 20 bytes of the merged file 32-1 constitutes the decryption code 28-1 and the next 20 bytes of the merged file 32-1 constitutes the unique identifier 30-1. In some implementations, the decryption code 28-1 and the unique identifier 30-1 may be in an encrypted format such that, in order to extract the decryption code 28-1 and the unique identifier 30-1 from the merged file 32-1, the extraction process must be aware of how to decrypt the decryption code 28-1 and the unique identifier 30-1. By way of non-limiting example, the decryption process may require a key, knowledge of a particular decryption algorithm, and/or knowledge of a predetermined format of the merged file 32-1.

In this example, assume that a user 40 associated with the requestor computing device 14 desires to obtain the private data 26-1. For example, the private data 26-1 may comprise a video that the user 40 would like to view on a display device 42 of the computing device 14. The user 40 obtains the merged file 32-1 and stores the merged file 32-1 on a storage device 46. In this example, the user 40 obtains a copy 32-1C of the merged file 32-1 by interacting with a service (not illustrated) that provides the merged file 32-1 to the user 40 for a fee.

The user 40 interacts with a client process 44 and requests the client process 44 to use the merged file 32-1 to obtain the private data 26-1. The client process 44 is aware of the format of the merged file 32-1 and how to decrypt the decryption code 28-1 and the unique identifier 30-1, if necessary.

The client process 44 extracts the decryption code 28-1 and the unique identifier 30-1 from the merged file 32-1. In this implementation, the unique identifier 30-1 comprises a portion of a uniform resource locator (URL) or a complete URL. For example, the unique identifier 30-1 may comprise a URL such as “WWW.AJAX.COM/121232123”. Alternatively, the unique identifier 30-1 may comprise the value “121232123”, and the client process 44 forms the URL “WWW.AJAX.COM/121232123” based on a predetermined domain name of WWW.AJAX.COM and the value “121232123”.

The client process 44 establishes a secure session, such as a transport layer security (TLS) session or a secure sockets layer (SSL) session, with the private data decrypter 36. The client process 44 initiates an HTTP post method to the URL and includes the decryption code 28-1. The private data decrypter 36 listens for HTTP POST calls to the URL. The private data decrypter 36 receives the decryption code 28-1. Because the private data decrypter 36 received the POST call on the URL WWW.AJAX.COM/121232123, the private data decrypter 36 extracts the unique ID 30-1 (e.g., “121232123”) from the URL. The private data decrypter 36 determines that the unique ID 30-1 corresponds to the trained MLM 24-1. The private data decrypter 36 provides the decryption code 28-1 to the trained MLM 24-1 as input. The trained MLM 24-1 returns, to the private data decrypter 36, the private data 26-1 in response the decryption code 28-1. The private data decrypter 36 then sends the private data 26-1 to the requestor computing device 14 via the secure session. In some implementations, the private data decrypter 36 may then permanently delete the trained MLM 24-1 so that the private data 26-1 cannot be obtained again.

In other implementations, rather than utilizing a particular URL containing the unique ID 30-1, the client process 44 establishes a secure session with the private data decrypter 36 and sends the unique ID 30-1 and the decryption code 28-1 to the private data decrypter 36 via any suitable inter-process communication mechanism, such as an application programming interface (API), or the like. The private data decrypter 36 determines that the unique ID 30-1 corresponds to the trained MLM 24-1. The private data decrypter 36 provides the decryption code 28-1 to the trained MLM 24-1 as input. The trained MLM 24-1 returns, to the private data decrypter 36, the private data 26-1 in response the decryption code 28-1. The private data decrypter 36 then sends the private data 26-1 to the requestor computing device 14 via the secure session.

FIG. 2 is a block diagram illustrating the generation of the trained MLM 24-1 according to one embodiment. The private data encrypter 34 iteratively trains an initially non-trained MLM 24 with two sets of data. A first set of data 47 comprises multiple copies of the decryption code 28-1, and instructions to the MLM 24 that upon receipt of the decryption code 28-1, the MLM 24 is to respond with the private data 26-1. A second set of data 48 comprises multiple random data that is not the private data 26-1, and instructions to the MLM 24 that upon receipt of any data that is not the decryption code 28-1, the MLM 24 is to respond with something other than the private data 26-1, such as a “null” value, a predetermined value, or some other value. The process iterates until the training accuracy and validation accuracy are one hundred percent correct, at which time it is determined that the MLM 24 has been overfitted and becomes the trained MLM 24-1. This may be determined, for example, utilizing callback techniques such as, by way of non-limiting example, Early Stopping and Model Checkpoints that facilitate training only for so long as necessary to reach the overfit state.

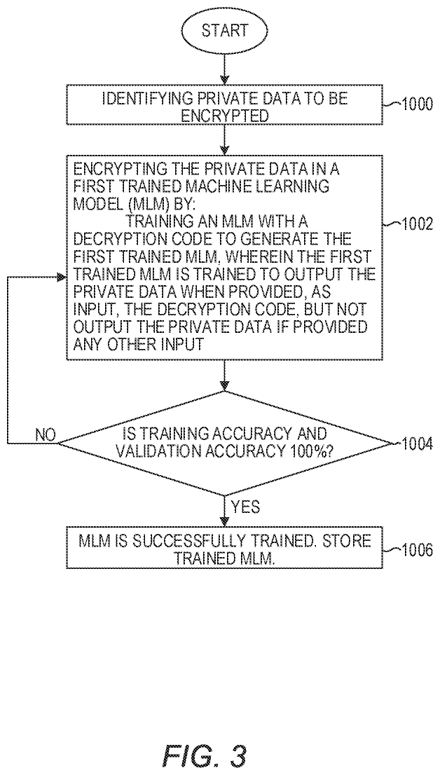

FIG. 3 is a flowchart of a method for encrypting private data into an MLM to generate a trained MLM according to one embodiment. FIG. 3 will be discussed in conjunction with FIG. 2. The private data encrypter 34 identifies the private data 26-1 to be encrypted (FIG. 3, block 1000). The private data encrypter 34 encrypts the private data 26-1 in the trained MLM 24-1 by training an MLM 24 with the decryption code 28-1 to generate the trained MLM 24-1, wherein the trained MLM 24-1 is trained to output the private data 26-1 when provided, as input, the decryption code 28-1, but not output the private data 26-1 if provided any other input (FIG. 3, block 1002). The private data encrypter 34 checks periodically to determine if the training accuracy and the validation accuracy are 100 percent (FIG. 3, block 1004). If not, the private data encrypter 34 returns to block 1002 and continues to iteratively train the MLM 24. If the training accuracy and the validation accuracy are 100 percent, the private data encrypter 34 determines that the MLM 24 has been successfully overfitted and stores the MLM 24 as the trained MLM 24-1 (FIG. 3, block 1006).

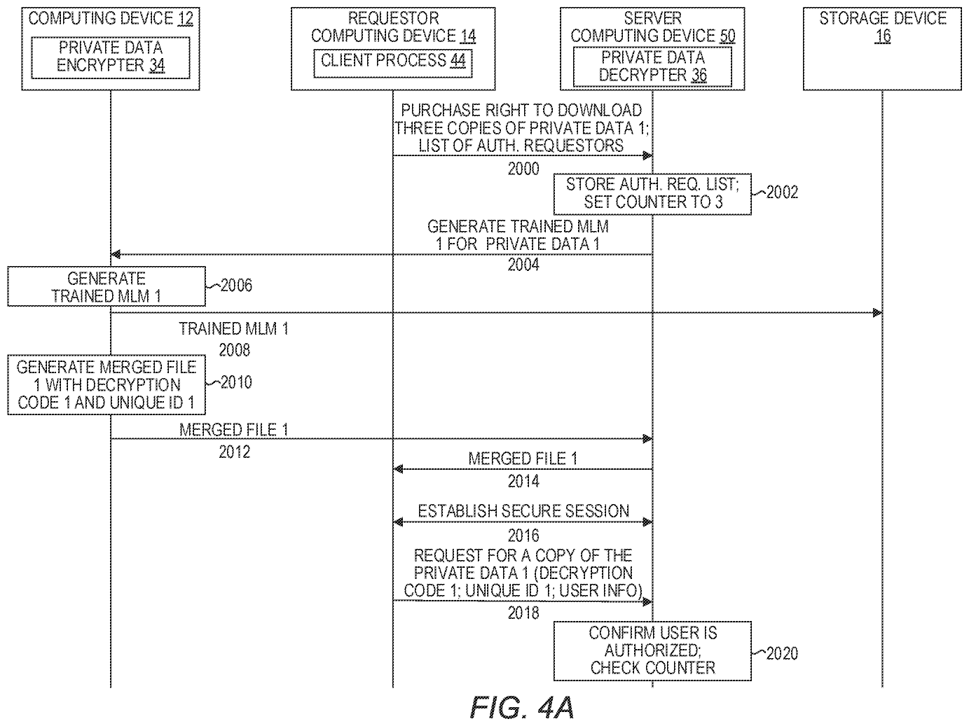

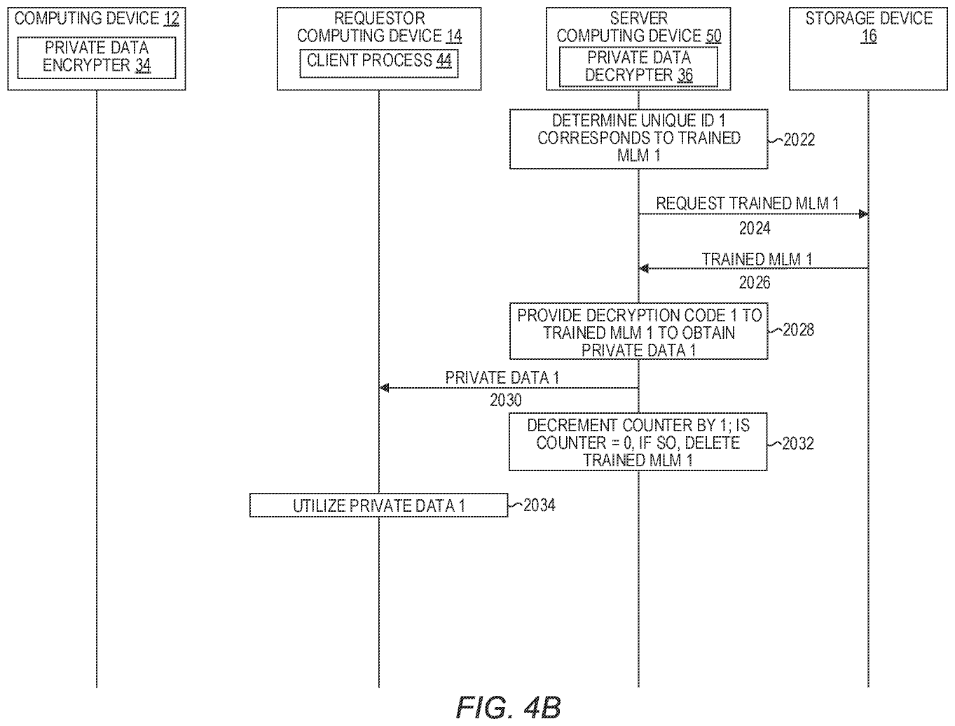

FIGS. 4A-4B illustrate a sequence diagram of messages communicated between and actions taken by various components according to another embodiment. In this embodiment, the private data encrypter 34 executes on the computing device 12, and the private data decrypter 36 executes on a server computing device 50. In this embodiment, the user 40 (FIG. 1), interacts with the requestor computing device 14 to purchase, from the server computing device 50, a right to download three copies of the private data 26-1 (step 2000). The user 40 also provides a list of authorized requestors who are authorized to download a copy of the private data 26-1. The server computing device 50 stores the list of authorized requestors and sets a counter to three (step 2002). The server computing device 50 sends a message to the private data encrypter 34 to generate the trained MLM 24-1 using the private data 26-1 (step 2004).

The private data encrypter 34 generates the trained MLM 24-1 to encode the private data 26-1 in the trained MLM 24-1, and to respond with the private data 26-1 when presented with the decryption code 28-1 (step 2006). The private data encrypter 34 stores the trained MLM 24-1 on the storage device 16 (step 2008). The private data encrypter 34 generates the unique identifier 30-1 and generates the merged file 32-1 using the unique identifier 30-1 and the decryption code 28-1 and provides the merged file 32-1 to the server computing device 50 (steps 2010, 2012). The server computing device 50 sends the merged file 32-1 to the requestor computing device 14 (step 2014).

At a future point in time, the user 40 decides to download a copy of the private data 26-1. The user 40 interacts with the requestor computing device 14 to initiate a secure session with the server computing device 50 (step 2016). The requestor computing device 14 sends a request to the server computing device 50 to download a copy of the private data 26-1, the request including the decryption code 28-1 and the unique identifier 30-1, and information identifying the user 40 (step 2018).

The server computing device 50 accesses the previously stored list of authorized requestors and confirms that the user 40 is authorized to request a copy of the private data 26-1. The server computing device 50 checks the counter to determine that additional copies of the private data 26-1 may be downloaded (step 2020).

Referring now to FIG. 4B, the server computing device 50 determines that the unique ID 30-1 corresponds to the trained MLM 24-1 (step 2022). The server computing device 50 obtains the trained MLM 24-1 from the storage device 16 (steps 2024, 2026). The private data decrypter 36 provides the decryption code 28-1 to the trained MLM 24-1 (step 2028). The trained MLM 24-1, in response to the decryption code 28-1, returns the private data 26-1 to the private data decrypter 36 as a prediction. The server computing device 50 sends the private data 26-1, via the secure session, to the requestor computing device 14 (step 2030). The server computing device 50 decrements the counter by a value of one and determines if the value of the counter is zero. If not, then the process is complete for the server computing device 50. If the value of the counter is zero, the server computing device 50 deletes the trained MLM 24-1 from the storage device 16 (not illustrated) (step 2032). The requestor computing device 14 utilizes the private data 26-1, such as by presenting the private data 26-1 to the user 40 (step 2034).

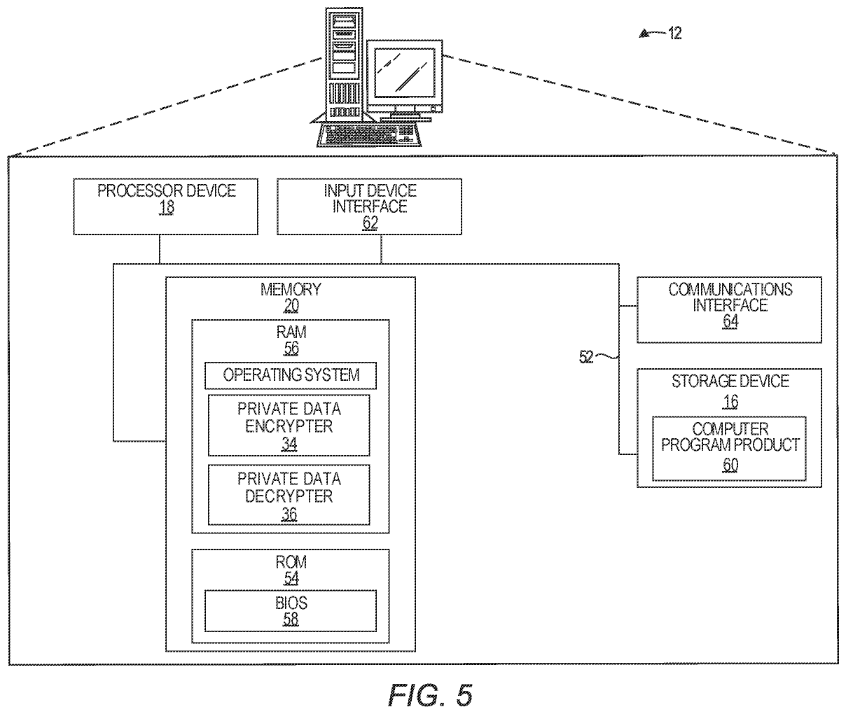

FIG. 5 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, or the like. The computing device 12 includes the processor device 18, the memory 20, and a system bus 52. The system bus 52 provides an interface for system components including, but not limited to, the memory 20 and the processor device 18. The processor device 18 can be any commercially available or proprietary processor.

The system bus 52 may be any of several types of bus structures that may further interconnect to a memory bus (with or without a memory controller), a peripheral bus, and/or a local bus using any of a variety of commercially available bus architectures. The memory 20 may include non-volatile memory 54 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 54 and can include the basic routines that help to transfer information between elements within the computing device 12. The volatile memory 56 may also include a high-speed RAM, such as static RAM, for caching data.

The computing device 12 may further include or be coupled to a non-transitory computer-readable storage medium such as the storage device 16, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 16 and other drives associated with computer-readable media and computer-usable media may provide non-volatile storage of data, data structures, computer-executable instructions, and the like.

A number of modules can be stored in the storage device 16 and in the volatile memory 56, including an operating system and one or more program modules, such as the private data encrypter 34 and/or the private data decrypter 36, which may implement the functionality described herein in whole or in part.

All or a portion of the embodiments may be implemented as a computer program product 60 stored on a transitory or non-transitory computer-usable or computer-readable storage medium, such as the storage device 16, which includes complex programming instructions, such as complex computer-readable program code, to cause the processor device 18 to carry out the steps described herein. Thus, the computer-readable program code can comprise software instructions for implementing the functionality of the examples described herein when executed on the processor device 18. The processor device 18, in conjunction with the private data encrypter 34 and/or the private data decrypter 36 in the volatile memory 56, may serve as a controller, or control system, for the computing device 12 that is to implement the functionality described herein.

The operator 38 may also be able to enter one or more configuration commands through a keyboard (not illustrated), a pointing device such as a mouse (not illustrated), or a touch-sensitive surface such as a display device. Such input devices may be connected to the processor device 18 through an input device interface 62 that is coupled to the system bus 52 but can be connected by other interfaces such as a parallel port, an Institute of Electrical and Electronic Engineers (IEEE) 1394 serial port, a Universal Serial Bus (USB) port, an infrared (IR) interface, and the like. The computing device 12 may also include a communications interface 64, such as an Ethernet transceiver or the like, suitable for communicating with the network 22 as appropriate or desired.

Those skilled in the art will recognize improvements and modifications to the preferred embodiments of the disclosure. All such improvements and modifications are considered within the scope of the concepts disclosed herein and the claims that follow.

What is claimed is:

1. A method comprising:
identifying, by a computing device, private data to be encrypted; and
encrypting the private data in a first trained machine learning model (MLM) by:
training an MLM with a decryption code to generate the first trained MLM, wherein the first trained MLM is trained to output the private data when provided, as input, the decryption code, but not output the private data if provided any other input.

2. The method of claim 1 wherein training the MLM with the decryption code further comprises:
iteratively training the MLM with the decryption code to overfit the MLM such that the first trained MLM outputs the private data only when the decryption code is provided as input.

3. The method of claim 1 wherein the decryption code is derived based on the private data.

4. The method of claim 1 wherein the decryption code is derived based on data other than the private data.

5. The method of claim 1 wherein the decryption code comprises an image having an image file format, and the private data is data other than an image.

6. The method of claim 1 further comprising:
receiving, from a requestor computing device, a request for the private data, the request including the decryption code and a unique identifier;
based on the unique identifier, selecting the first trained MLM from a plurality of different trained MLMs;
providing to the first trained MLM, as input, the decryption code;
receiving, from the first trained MLM in response to the decryption code, the private data; and
sending, to the requestor computing device, the private data.

7. The method of claim 6 further comprising:
prior to sending the private data, establishing, with the requestor computing device, a secure session, and wherein sending the private data to the requestor computing device comprises sending the private data to the requestor computing device via the secure session.

8. The method of claim 7 wherein the secure session is one of a transport layer security (TLS) session and a secure sockets layer (SSL) session.

9. The method of claim 6 further comprising, in response to sending the private data to the requestor computing device, permanently deleting the first trained MLM.

10. The method of claim 6 further comprising:
incrementing a counter;
determining that the counter is equal to a predetermined allowed requests value; and
in response to determining that the counter is equal to the predetermined allowed requests value, permanently deleting the first trained MLM.

11. The method of claim 6 further comprising:
prior to sending the private data to the requestor computing device, accessing, by the computing device, information that identifies an authorized requestor for the private data; and
determining, based on information included in the request, that the request is associated with the authorized requestor.

12. The method of claim 1 wherein training the MLM with the decryption code further comprises:
training the MLM with the decryption code and a plurality of other codes such that the first trained MLM outputs data other than the private data if provided with any code other than the decryption code.

13. The method of claim 1 wherein the first trained MLM comprises one of a Hierarchical Data Format 5 (HDF5) format and a Network Common Data Form (NetCDF) format.

14. The method of claim 1 further comprising:
generating a unique identifier that corresponds to the first trained MLM;
generating a file comprising the decryption code and the unique identifier; and
sending the file to a destination.

15. The method of claim 14 further comprising:
generating a unique uniform resource locator based on the unique identifier;
receiving, from a requestor computing device via the unique uniform resource locator, a request for the private data, the request including the decryption code and the unique identifier;
based on the unique identifier, selecting the first trained MLM from a plurality of different trained MLMs;
providing to the first trained MLM, as input, the decryption code;
receiving, from the first trained MLM in response to the decryption code, the private data; and
sending, to the requestor computing device, the private data.

16. A computer system comprising:
a processor device set comprising one or more processor devices of one or more computing devices, the processor device set configured to:
identify private data to be encrypted; and
encrypt the private data in a first trained machine learning model (MLM) by:
training an MLM with a decryption code to generate the first trained MLM, wherein the first trained MLM is trained to output the private data when provided, as input, the decryption code, but not output the private data if provided any other input.

17. The computer system of claim 16 wherein, to train the MLM with the decryption code, the processor device set is further configured to:
iteratively train the MLM with the decryption code to overfit the MLM such that the first trained MLM outputs the private data only when the decryption code is provided as input.

18. The computer system of claim 16 wherein the processor device set is further configured to:
receive, from a requestor computing device, a request for the private data, the request including the decryption code and a unique identifier;
based on the unique identifier, select the first trained MLM from a plurality of different trained MLMs;
provide to the first trained MLM, as input, the decryption code;
receive, from the first trained MLM in response to the decryption code, the private data; and
send, to the requestor computing device, the private data.

19. A non-transitory computer-readable storage medium that includes executable instructions configured to cause a processor device set comprising one or more processor devices to:
identify private data to be encrypted; and
encrypt the private data in a first trained machine learning model (MLM) by:
training an MLM with a decryption code to generate the first trained MLM, wherein the first trained MLM is trained to output the private data when provided, as input, the decryption code, but not output the private data if provided any other input.

20. The non-transitory computer-readable storage medium of claim 19 wherein to train the MLM with the decryption code, the executable instructions are further configured to cause the processor device set to:
iteratively train the MLM with the decryption code to overfit the MLM such that the first trained MLM outputs the private data only when the decryption code is provided as input.
